(19) United States
(12) Patent Application Publication
(10) Pub. No.: US 2011/0216821 A1
(43) Pub. Date: Sep. 8, 2011

(54) METHOD AND APPARATUS FOR ADAPTIVE STREAMING USING SCALABLE VIDEO CODING SCHEME

(75) Inventors: Dae-Hee KIM, Suwon-si (KR); Hyun-Mun KIM, Seongnam-si (KR); Dae-Sung CHO, Seoul (KR); Woong-Il CHOI, Hwaseong-si (KR); Min-Woo PARK, Yongin-si (KR)

(73) Assignee: SAMSUNG ELECTRONICS CO., LTD., Suwon-si (KR)

(21) Appl. No.: 13/038,619

(22) Filed: Mar. 2, 2011

Related U.S. Application Data
(60) Provisional application No. 61/309,641, filed on Mar. 2, 2010.

(51) Int. Cl. H04N 7/26

(52) U.S. Cl. 375/240.02; 375/E07.126

(57) ABSTRACT

A method which provides a video streaming service, and the method includes: generating layer data for a corresponding video in accordance with a layer coding scheme using residual data; receiving bit rate information including a bit rate decodable in a terminal from the terminal; selecting a layer necessary for a decoding of a video corresponding to the decodable bit rate from among the generated layer data; and transmitting layer information and layer data corresponding to the selected layer to the terminal.

### CROSS-REFERENCE TO RELATED APPLICATION

This application claims the benefit under 35 U.S.C. §119(a) to a U.S. patent application entitled “Method and Apparatus for Adaptive Streaming Using Scalable Video Coding Scheme” filed in the U.S. Patent and Trademark Office on Mar. 2, 2010 and assigned Ser. No. 61/309,641, the contents of which are incorporated herein by reference.

### BACKGROUND

1. Field

Apparatuses and methods consistent with to scalable video coding, and more particularly, to a method and an apparatus for performing scalable video coding in adaptive video streaming.

2. Description of the Related Art

The adaptive video streaming refers to a video streaming service provided in different bit rates according to a state of a network or a terminal.

An example of the adaptive video streaming includes the smooth streaming. The smooth streaming adaptively provides a user with videos having different bit rates according to a state of a variable network and terminal, e.g., a CPU state of the terminal, so that the user can enjoy the video without buffering the video if the state of the network or the terminal becomes poor.

However, the conventional adaptive video streaming scheme separately codes and stores all the videos having different bit rates, so that a load of the server is increased.

FIG. 1 is a diagram illustrating a video coding and transmission scheme in the conventional adaptive video streaming. In FIG. 1, it is assumed that a server 110 provides a terminal 120 with videos having three types of bit rates, 10 kbps, 20 kbps, and 30 kbps. In the conventional scheme, the server 110 separately codes and stores all the videos corresponding to the three types of bit rates. Reference numbers 111, 112, and 113 refer to the videos having the bit rates of 10 kbps, 20 kbps, and 30 kbps for a predetermined time unit. In the next time unit, the videos having the bit rates of 10 kbps, 20 kbps, and 30 k are also identically coded and stored separately. For reference, the predetermined time unit is generally called a fragment.

In a state in which the server 110 separately codes and stores the videos having the different bit rates, the server 110 transmits one of the three videos 111, 112, and 113 according to a state of a network and a terminal. According to this streaming scheme, the server 110 codes and stores the video corresponding to a bit rate of 60 kbps for a time unit, i.e., a single fragment.

FIG. 1 is assumed that the videos having the three different types of bit rates are streamed. However, if the number of videos having different bit rates increases, a size of the videos to be stored by the server 110 is greatly increased. Further, it is not illustrated in FIG. 1, but the videos are transmitted to the terminal 120 through multiple intermediate nodes. In this case, as the size of the videos increases, the intermediate nodes must store and process a larger size of the corresponding video.

### SUMMARY

Accordingly, aspects of the exemplary embodiments provide a method and an apparatus for adaptive video streaming using a multi-layer video coding scheme.

Also, exemplary embodiments provide a method and an apparatus for adaptively selecting layer data according to state information of a terminal and providing a video streaming service.

In accordance with an exemplary embodiment, there is provided a method for a video streaming service, the method including: generating layer data for a corresponding video in accordance with a layer coding scheme using residual data; receiving bit rate information including a bit rate decodable in a terminal from the terminal; selecting a layer necessary for a decoding of a video corresponding to the decodable bit rate from among the generated layer data; and transmitting layer information and layer data corresponding to the selected layer to the terminal.

In accordance with another exemplary embodiment, there is provided a method which receives a video streaming service, the method including: transmitting bit rate information including a bit rate decodable in a terminal to a server; receiving layer information and layer data corresponding to a layer selected by the server from the server in order to decode a video corresponding to the decodable bit rate; and decoding the video corresponding to the decodable bit rate by using the layer information and the layer data, in which the layer selected by the server is selected from among layer data generated for the corresponding video in accordance with a layer coding scheme using residual data.

In accordance with another exemplary embodiment, there is provided an apparatus for a video streaming service, the apparatus including: a scalable coding unit which generates layer data for a corresponding video in accordance with a layer coding scheme using residual data; a controller which receives bit rate information including a bit rate decodable in a terminal from the terminal and selecting a layer necessary for a decoding of a video corresponding to the decodable bit rate from among the generated layer data; and a multiplexer which multiplexes layer information and layer data corresponding to the selected layer to the terminal and transmitting the multiplexed layer information and layer data.

In accordance with another exemplary embodiment, there is provided an apparatus which receives a video streaming service, the apparatus including: a controller which transmits bit rate information including a bit rate decodable in a terminal to a server; a demultiplexer which receives and demultiplexes layer information and layer data corresponding to a layer selected by the server from the server in order to decode a video corresponding to the decodable bit rate; and a scalable decoding unit which decodes the video corresponding to the decodable bit rate by using the layer information and the layer data, in which the layer selected by the server is selected from among the layer data generated for the corresponding video in accordance with a layer coding scheme using residual data.

According to an exemplary embodiment, the server generates the layer data for the video in accordance with the layer coding scheme using the residual data, the terminal transmits the bit rate information of the bit rate decodable in the terminal to the server considering the state of the network or terminal, and the server selects the layer necessary for the decoding of the video corresponding to the bit rate information from among the layer data and transmits the layer information and the layer data of the selected layer to the terminal.

Therefore, a size of data stored in the server or the intermediate node is reduced. Further, the terminal can adaptively receive the layer data providing the scalability according to the state of the network or terminal, so that the state of the network or terminal can be applied to the streaming service in real time.

### BRIEF DESCRIPTION OF THE DRAWINGS

The above and/or other aspects, features and advantages of the present inventive concept will be more apparent from the following detailed description taken in conjunction with the accompanying drawings, in which:

FIG. 1 is a diagram illustrating a video coding and transmission scheme in adaptively streaming a video according to a conventional art;

FIG. 2 is a diagram illustrating a scheme of providing a network adaptive streaming service according to a multi-layer coding scheme using residual video according to an exemplary embodiment;

FIG. 3 is a diagram illustrating a construction of a server according to an exemplary embodiment;

FIG. 4 is a diagram illustrating a construction of a terminal according to an exemplary embodiment;

FIG. 5 is a flowchart illustrating an operation of a server according to an exemplary embodiment; and

FIG. 6 is a flowchart illustrating an operation of a terminal according to an exemplary embodiment.

### DETAILED DESCRIPTION OF EXEMPLARY EMBODIMENTS

Hereinafter, the exemplary embodiments will be described with reference to the accompanying drawings. In the following description, the same elements will be designated by the same reference numerals although they are shown in different drawings.

An exemplary embodiment provides an adaptive video streaming service employing a Scalable Video Coding (SVC) according to a request of a terminal.

Specifically, a server preferentially codes a plurality of layer data necessary for the support of plural bit rates for a corresponding video in accordance with a multi-layer coding scheme using residual data and stores the encoded data. Then, when the server receives a request for the corresponding video from the terminal, the server transmits entire bit rate information including bit rates supported by the server, fragment information, and base layer data of the corresponding video to the terminal.

The terminal decodes the video by using the base layer data. The terminal monitors a current state of the terminal or a network and selects a single bit rate from among the plural bit rates based on the monitoring result. Then, the terminal transmits the selected bit rate to the server. The server selects layer data necessary for the decoding of the video corresponding to the received bit rate from among the stored layer data and transmits the selected layer data and layer information of the selected layer data to the terminal. The terminal decodes the video corresponding to the bit rate selected by the terminal by using the received layer information and layer data.

Hereinafter, an exemplary embodiment will be described in detail.

A Scalable Video Coding (SVC) refers to the video coding technology which constructs a single bit stream so that a single video content has various spatial resolutions, definitions and frame rates, and thus enables several terminals to receive the bit stream appropriate to the capability of a corresponding terminal to restore the video. A purpose of the SVC technology is to provide the various terminals and network environments with the optimum service.

The SVC according to an exemplary embodiment is implemented by the multi-layer coding scheme using the residual video. The multi-layer coding refers to a scheme of generating layered video data with one-time coding in a coding device, wherein when the video is coded using the residual video, a size of video data is reduced, so that a size of the video data to be stored in the server is decreased.

FIG. 2 illustrates a scheme of providing a network adaptive streaming service according to the multi-layer coding scheme using a residual video according to an exemplary embodiment.

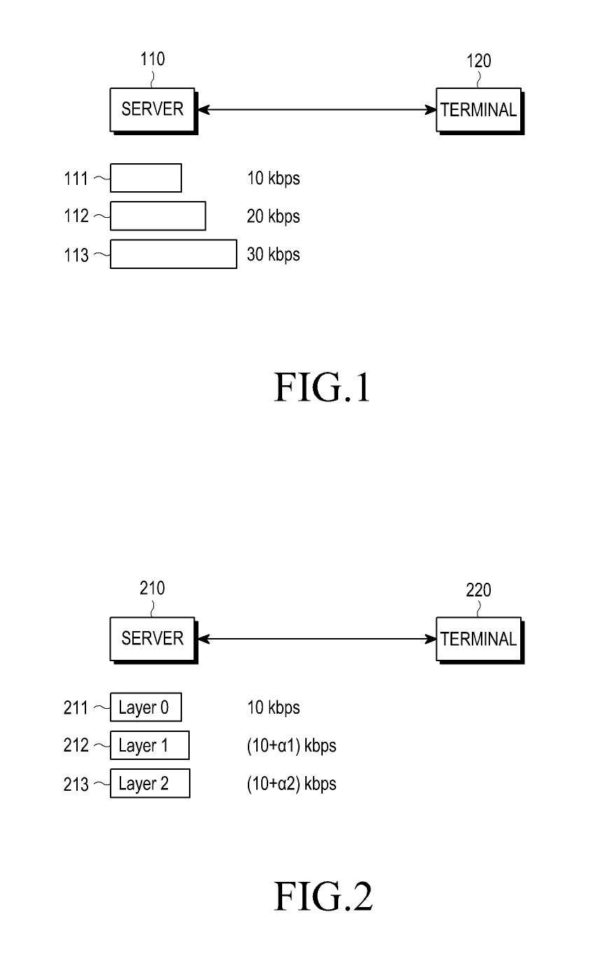

In FIG. 2, it is assumed that that a server 210 provides a terminal 220 with videos having three types of bit rates, 10 kbps, 20 kbps, and 30 kbps, similar to FIG. 1. However, the bit rates of 10 kbps, 20 kbps, and 30 kbps are only examples for convenience of the description, and it is a matter of course that an actual bit rate can be changed depending on a system. The server 210 uses the multi-layer coding scheme using residual data in order to provide the terminal 220 with the network adaptive streaming service. For reference, each of layer data in multi-layer coding can be a time layer, a spatial layer, a Signal to Noise Ratio (SNR) layer, etc.

An example of the multi-layer coding scheme using the residual video is as follows.

Zero layer data 211 of a base layer is identical to the data 111 of the coded video having the bit rate of 10 kbps illustrated in FIG. 1. First layer data 212 is coded data of residual data which corresponds to a difference between the up-converted zero layer data 211 and the original video data having the bit rate of 20 kbps. Further, second layer data 213 is coded data of residual data which corresponds to a difference between the up-converted first layer data 212 and the original video data having the bit rate of 30 kbps.

In FIG. 1, the server does not code the video by using the residual video, so that the bit rate of the first layer data 112 is 20 kbps and the bit rate of the second layer data 113 is 30 kbps. However, the server 210 according to an exemplary embodiment codes the layer data of a low degree by using the residue of the difference between the up-converted data and the original video data, so that the bit rate of each of the layer data is as low as about 10 kbps over the bit rate of the original video data.

Referring to FIG. 2, the bit rate of the first layer data 212 is (10+α1) kbps and the bit rate of the second layer data 213 is (10+α2) kbps. In this regard, each of the values of α1 and α2 is a value greatly smaller than 10. Therefore, the bit rate of the data to be stored by the server 210 is {10+(10+α1)+(10+α2)}=(30+α1+α2) kbps, wherein (α1+α2) is a very small value.

In comparison with the bit rate of the video data stored by the server 210 of FIG. 2 and the bit rate of the video data stored by the server 110 of FIG. 1, the server 110 of FIG. 1 stores the video data of the bit rate of 60 kbps, but the server 210 of FIG. 2 stores the video data of the bit rate of (30+α1+α2) kbps. The value of (α1+α2) is a very small value compared to 30, so that the bit rate of the video stored by the server 210 of FIG. 2 is much smaller than that of the video stored by the server 110 of FIG. 1. Therefore, in the multi-layer data coding scheme by using the residual video as illustrated in FIG. 2, the size of the video stored by the server 210 becomes advantageously very small.

As described above, the server 210 codes the corresponding video in accordance with the multi-layer data coding scheme using the residue and stores the multi-layer data. Then, when the server 210 receives a request for the corresponding video from the terminal 220, the server 210 transmits entire bit rate information indicating bit rates supportable by the server 210 for the corresponding video to the terminal 210.

That is, in the above example, the server 210 transmits the entire bit rate information in order to make a report that the server 210 can support the bit rates of 10 kbps, 20 kbps, and 30 kbps. The entire bit rate information can be constructed in a format including the bit rate supportable by the server 210 and layer information necessary for the decoding of the corresponding bit rate, for example, “10 kbps=zero layer”, “20 kbps=zero layer+first-layer”, and “30 kbps=zero layer+first layer+second layer”. The terminal 220 may select a single bit rate from among the bit rates included in the entire bit rate information or select layer information mapped to the selected bit rate, and transmit the selected bit rate or the selected layer information to the server 210. The entire bit rate information can be periodically transmitted. Further, when the format of the video data is renewed, etc., the entire bit rate information can be aperiodically transmitted.

In the meantime, the server 210 transmits fragment information and base layer data together with the entire bit rate information. Then, the terminal 220 decodes the base layer video, i.e. the video of the bit rate of 10 kbps in the example, by using the base layer data. For reference, the fragment refers to a time unit for which the data is transmitted. For example, the zero layer data and the layer information are multiplexed and transmitted in the zero^{th} fragment, the zero layer data, the first layer data, the second layer data, and the layer information are multiplexed and transmitted in the i^{th} fragment, and the zero layer data, the first layer data, and the layer information are transmitted in the (i+1)^{th} fragment.

In the meantime, the terminal 220 monitors a state of the network or the terminal. When the terminal 220 can decode the video of a different bit rate from that of the currently decoded video according to the monitoring result, the terminal 220 selects a single bit rate from among the bit rates included in the entire bit rate information indicating the bit rates supportable by the server 210 and transmits bit rate information indicating the selected bit rate to the server 210. The server 210 selects a layer necessary for the decoding of the video corresponding to the selected bit rate and transmits layer information and layer data corresponding to the selected layer to the terminal 220.

In the aforementioned example, when the terminal 220 can decode the video of the bit rate of 20 kbps, the terminal 220 makes a report of the decoding possibility of the video of the bit rate of 20 kbps to the server 210, and the server 210 selects the zero layer data 211 and the first layer data 212 in the corresponding fragment and transmits the layer data and the layer information of the selected layer to the terminal 220. Then, the terminal 220 decodes the video of the bit rate of 20 kbps by using the zero layer data 211 and the first layer data 212.

If the terminal 220 can decode the video of the bit rate of 30 kbps, the terminal 220 makes a report of the decoding possibility of the video of the bit rate of 30 kbps to the server 210, and the server 210 selects the zero layer data 211, the first layer data 212, and the second layer data 213 in the corresponding fragment and transmits the layer data and the layer information of the selected layer to the terminal 220. Then, the terminal 220 decodes the video of the bit rate of 30 kbps by using the zero layer data 211, the first layer data 212, and the second layer data 213.

In the meantime, the bit rate information can be periodically or aperiodically transmitted from the terminal 220 to the server 210. In the event that the bit rate information transmitted is aperiodically transmitted, when the state of the network or terminal has a value larger than a predetermined reference value or a value equal to or less than the predetermined reference value while the terminal 220 monitors the state of the network or terminal, the terminal 220 can select a single bit rate from among the bit rates included in the entire bit rate information based on the identified state value and transmit the information of the selected bit rate to the server 220 at a corresponding time point.

In another embodiment, the server 210 does not receive the bit rate information from the terminal 220, but can self-measure the state of the network or terminal, select an appropriate bit rate in the corresponding fragment, and transmit layer data and layer information corresponding to the selected bit rate to the terminal 220.

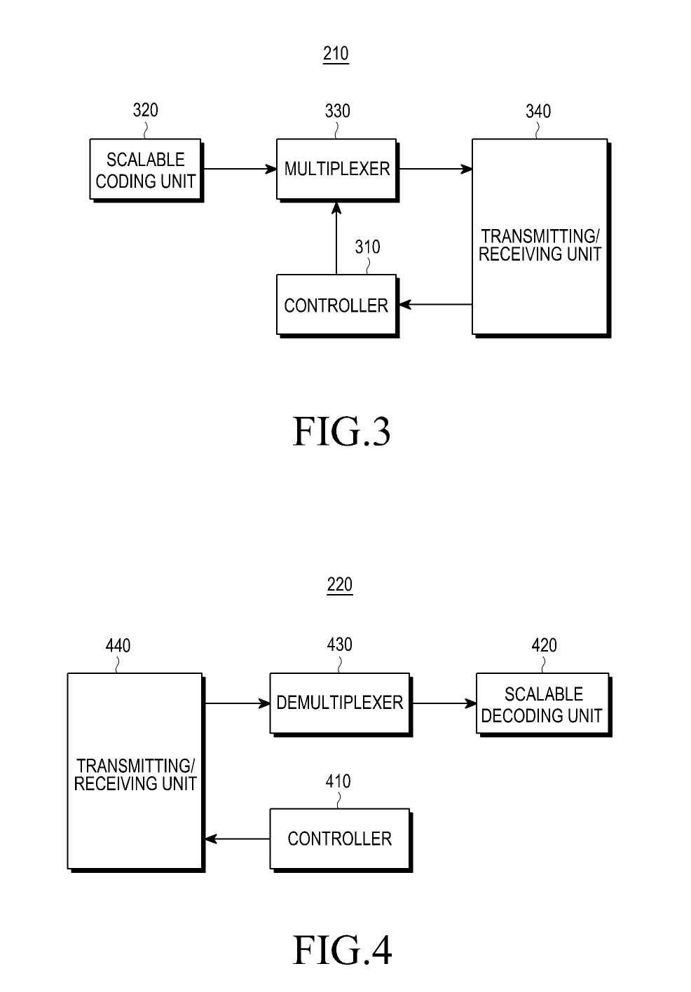

FIG. 3 is a diagram illustrating a construction of the server according an exemplary embodiment.

The server 210 includes a controller 310, a scalable coding unit 320, a multiplexer 330, and a transmitting/receiving unit 340.

The scalable coding unit 320 generates, codes, and stores at least two layer data for a corresponding video. For reference, in FIG. 2, the three layers are exemplified for description, but the number of layers can be changed according to the implementation of the system. Further, the specific construction of the scalable coding unit 320 can be implemented in various schemes, but their description will be omitted.

When the controller 310 receives an initial request for the corresponding video from the terminal 220 through the transmitting/receiving unit 340, the controller 310 transmits entire bit rate information, fragment information, and base layer data of the corresponding video to the terminal 220. Further, the controller 310 receives bit rate information indicating the bit rate, which the terminal 220 selects from among the bit rates included in the entire bit rate information, through the transmitting/receiving unit 340, selects a layer according to the received bit rate information, and transfers layer information and layer data of the selected layer to the multiplexer 330.

The multiplexer 330 multiplexes the layer data and the layer information into a predetermined format and transmits the multiplexed layer data and layer information to the terminal 220 through the transmitting/receiving unit 340.

FIG. 4 is a diagram illustrating a construction of the terminal according to an exemplary embodiment.

A controller 410 makes a request for a video to the server 210, receives entire bit rate information, fragment information, and base layer information of the corresponding video from the server 210, and restores a basic video by using the received information. Further, the controller 410 monitors a state of the terminal or network, selects a single bit rate decodable in the terminal 220 from among the bit rates included in the entire bit rate information according to the monitoring result, generates bit rate information indicating the selected bit rate, and transmits the generated bit rate information to the server 210. Then, the controller 410 receives data in which layer information and layer data of the layer selected in the server 210 according to the transmitted bit rate information are multiplexed, and transmits the multiplexed data to a demultiplexer 430. The demultiplexer 430 demultiplexes the multiplexed data to the layer information and the layer data and transfers the demultiplexed layer information and layer data to a scalable decoding unit 420.

The scalable decoding unit 420 decodes the video in accordance with the multi-layer video decoding scheme by using the layer information and the layer data. The specific construction of the scalable decoding unit 420 can be implemented in various schemes, but their description will be omitted.

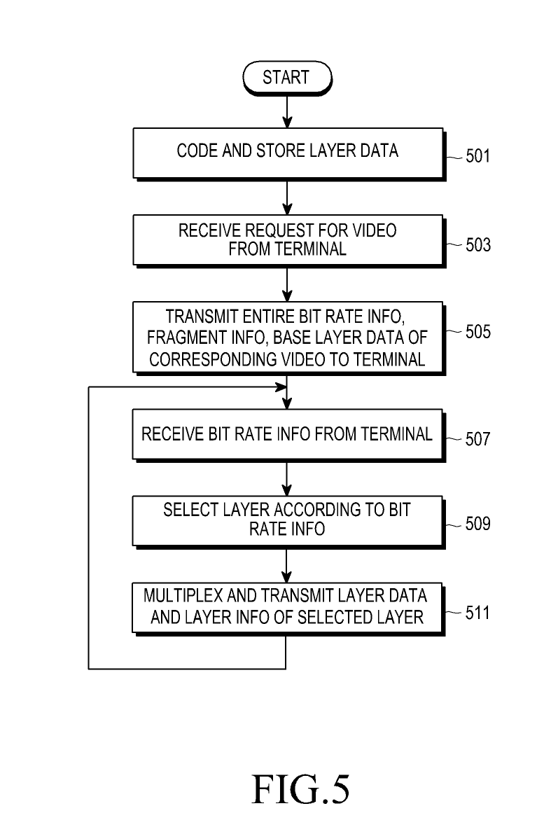

FIG. 5 is a flowchart illustrating an operation of the server according to an exemplary embodiment.

In step 501, the server generates, codes, and stores at least two layer data for a corresponding video. When the server receives an initial request for the corresponding video from the terminal in step 503, the server transmits entire bit rate information, fragment information, and base layer data of the corresponding video to the terminal in step 505.

In step 507, the server receives bit rate information indicating the bit rate selected from among the bit rates included in the entire bit rate information from the terminal. In step 509, the server selects a layer according to the received bit rate information. In step 511, the server multiplexes the layer information and the layer data of the selected layer into a predetermined format and transmits the multiplexed layer information and layer data to the terminal. Thereafter, steps 507 to 511 are repeated.

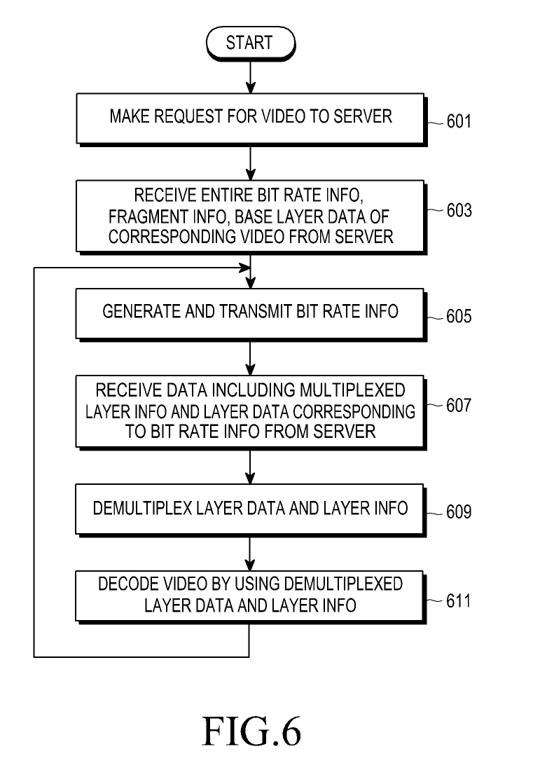

FIG. 6 is a flowchart illustrating an operation of the terminal according to an exemplary embodiment.

In step 601, the terminal makes a request for a video to the server. In step 603, the terminal receives entire bit rate information, fragment information, and base layer information of the corresponding video from the server and restores a basic video by using the received information.

In step 605, the terminal monitors a state of the terminal or network, selects a bit rate decodable in the terminal from among the bit rates included in the entire bit rate information based on the monitoring result, generates bit rate information indicating the selected bit rate, and transmits the generated bit rate information to the server.

In step 607, the terminal receives data into which layer data and layer information of the layer selected in the server according to the transmitted bit rate are multiplexed. In step 609, the terminal demultiplexes the multiplexed data to the layer information and the layer data. In step 611, the terminal decodes the corresponding video in accordance with the multi-layer video decoding scheme by using the demultiplexed layer information and layer data. Thereafter, steps 605 to 611 are repeated.

While the inventive concept has been shown and described with reference to certain exemplary embodiments and drawings thereof, it will be understood by those skilled in the art that various changes in form and details may be made therein without departing from the spirit and scope of the inventive concept as defined by the appended claims.

What is claimed is:

1. A method for providing a video streaming service, the method comprising:
generating layer data for a corresponding video in accordance with a layer coding scheme using residual data;
receiving bit rate information including a bit rate decodable in a terminal, at the terminal;
selecting a layer for a decoding of a video corresponding to the bit rate decodable in the terminal, from among the generated layer data; and
transmitting layer information and layer data corresponding to the selected layer to the terminal.

2. The method as claimed in claim 1, further comprising, after the generating of the layer data, transmitting entire bit rate information including bit rates supportable in a server for the corresponding video when a request for the corresponding video is received from the terminal.

3. The method as claimed in claim 2, wherein the bit rate information including the bit rate decodable in the terminal is selected by the terminal from among the bit rates included in the entire bit rate information by considering a state of the terminal or a network.

4. A method for receiving a video streaming service, the method comprising:
transmitting bit rate information including a bit rate decodable in a terminal, to a server;
receiving layer information and layer data corresponding to a layer selected by the server, from the server to decode a video corresponding to the bit rate decodable in the terminal; and
decoding the video corresponding to the bit rate decodable in the terminal, by using the layer information and the layer data, in which the layer selected by the server is selected from among the layer data generated for the corresponding video in accordance with a layer coding scheme using residual data.

5. The method as claimed in claim 4, further comprising:
before the transmitting of the bit rate information to the server,
transmitting a request for the corresponding video to the server; and
receiving entire bit rate information including bit rates supportable in the server for the corresponding video.

6. The method as claimed in claim 5, wherein the bit rate information including the bit rate decodable in the terminal is selected by the terminal from the bit rates included in the entire bit rate information by considering a state of the terminal or a network.

7. An apparatus which provides a video streaming service, the apparatus comprising:
a scalable coding unit which generates layer data for a corresponding video in accordance with a layer coding scheme using residual data;
a controller which receives bit rate information including a bit rate decodable in a terminal, from the terminal and which selects a layer for decoding a video corresponding to the decodable bit rate from among the generated layer data; and
a multiplexer which multiplexes layer information and layer data corresponding to the selected layer and which transmits the multiplexed layer information and layer data to the terminal.

8. The apparatus as claimed in claim 7, wherein when a request for the corresponding video is received from the terminal, the controller transmits entire bit rate information including bit rates supportable in a server for the corresponding video.

9. The apparatus as claimed in claim 8, wherein the bit rate information including the bit rate decodable in the terminal is selected by the terminal from among the bit rates included in the entire bit rate information by considering a state of the terminal or a network.

10. An apparatus which receives a video streaming service, the apparatus comprising:
a controller which transmits bit rate information including a bit rate decodable in a terminal, to a server;
a demultiplexer which receives and demultiplexes layer information and layer data corresponding to a layer selected by the server, from the server to decode a video corresponding to the bit rate decodable in the terminal; and
a scalable decoding unit which decodes the video corresponding to the bit rate decodable in the terminal by using the layer information and the layer data,
in which the layer selected by the server is selected from among the layer data generated for the corresponding video in accordance with a layer coding scheme using residual data.

11. The apparatus as claimed in claim 10, wherein the controller transmits a request for the corresponding video to the server and receives entire bit rate information including bit rates supportable in the server for the corresponding video.

12. The apparatus as claimed in claim 11, wherein the bit rate information including the bit rate decodable in the terminal is selected by the terminal from among the bit rates included in the entire bit rate information by considering a state of the terminal or network.

13. The method as claimed in claim 5, wherein the bit rate information is periodically or aperiodically transmitted from the terminal to the server.

14. The method as claimed in claim 5, wherein the terminal monitors a state value of the terminal or a network, and the terminal selects a single bit rate from among the bit rates included in the entire bit rate information based on the monitored state value of the network or terminal and transmits the bit rate information of the selected bit rate to the server.

15. An apparatus which provides a video streaming service, the apparatus comprising:
a scalable coding unit which generates layer data for a corresponding video in accordance with a layer coding scheme using residual data;
a controller which measures bit rate information including a bit rate decodable by a terminal, from the terminal and which selects a layer for decoding a video corresponding to the bit rate decodable by the terminal from among the generated layer data; and
a multiplexer which multiplexes layer information and layer data corresponding to the selected layer and which transmits the multiplexed layer information and layer data to the terminal.

16. The apparatus as claimed in claim 15, wherein the controller transmits entire bit rate information including bit rates supportable in a server for the corresponding video to the terminal based on the measured bit rate information.
